(19) United States
(12) Patent Application Publication
(10) Pub. No.: US 2008/0149905 A1
(43) Pub. Date: Jun. 26, 2008

(54) Inflatable Jack for a Vehicle

(75) Inventor: Ernesto Fidel Fernandez, New South Wales (AU)

Correspondence Address: COLLEN IP, THE HOLYOKE MANHATTAN BUILDING, 80 SOUTH HIGHLAND AVENUE, OSSINING, NY, 10562, US

(73) Assignee: KINGSLEY ENTERPRISES PTY LIMITED, Ingleburn, NSW (AU)

(21) Appl. No.: 11/719,481

(22) PCT Filed: Nov. 8, 2005
(86) PCT No.: PCT/AU2005/001708

§ 371 Date: May 16, 2007

(30) Foreign Application Priority Data
Nov. 16, 2004 (AU) 2004906551

(51) Int. Cl. B66F 3/24; B66F 3/35

(52) U.S. Cl. 254/93 HP

(57) ABSTRACT

An inflatable jack for a vehicle, the inflatable jack comprising a working chamber of sealed flexible material having a side wall, a top wall and a bottom wall. The top wall having an outer wall layer and an inner wall layer with a semi-rigid plastic member sandwiched there between. The inflatable jack also comprising first and second entry points for introducing compressed gas to inflate said working chamber, the first entry point adapted to receive compressed gas via a hose from the vehicle's exhaust, and the second entry point adapted to receive compressed gas via a hose from an air compressor.

### TECHNICAL FIELD

The present invention relates to inflatable jacks for a vehicle.

### BACKGROUND

Known inflatable jacks use inflatable bags to hydraulically, as opposed to mechanically, lift vehicles. The devices are placed under a lift point of the vehicle and inflated. As the inflatable bag expands, sufficient hydraulic force is generated to lift the vehicle to perform a necessary task, for example changing a tyre. The bags are typically inflated using a compressed gas cartridge or portable hand pump that presses air, or other liquid/gas, into the inflatable bag via a hose connected to a valve or other fitting on the bag. The problem with using gas cartridges has been that they are only good for a single use, after which they must be recharged or discarded. Whilst devices relying on hand pumps are reusable, they are slow and labour intensive to use.

A problem with the prior art has been that the top portion of the inflatable bag is susceptible to frictional erosion and puncture from the often jagged lift points on the undercarriage of vehicles. The problem is exacerbated as the lift points corrode or rust, sharpening their edges. Some prior art devices attempt to prolong the useable life of inflatable jacks by introducing a thick resilient top layer where contact is made to a lift point. However, even resilient top layers are susceptible to puncture.

A further problem inherent to inflatable jacks is that the flexible material of the bags gives little structural integrity, and protruding members give way to early failure. Attempts to solve this have included introducing horizontally wrapped reinforcement belts between sections of the bag that are spherical in shape. Some devices have used reinforcing material, such as a wire grid, into the top layer to prevent the top portion of the inflatable bag from protruding. They have been developed for lifting large vehicles, such as heavy, multiple axle trucks. These methods introduce complexity that increases manufacturing costs and the number of friction wear points on the bags.

The present invention seeks to provide an improved inflatable jack for a vehicle that will overcome the deficiencies of the prior art.

### SUMMARY OF THE INVENTION

According to a first aspect, the invention consists in an inflatable jack for a vehicle, said inflatable jack comprising a working chamber of sealed flexible material having a side wall, a top wall and a bottom wall, said top wall having an outer wall layer and an inner wall layer with a semi-rigid plastic member sandwiched there between, first and second entry points for introducing compressed gas to inflate said working chamber, said first entry point adapted to receive compressed gas via a hose from said vehicle's exhaust, said second entry point adapted to receive compressed gas via a hose from an air compressor.

Preferably, said air compressor is portable and powered from said vehicle's electrical distribution system.

Preferably, a skirt is disposed around the upper portion of said side wall to reinforce said working chamber when inflated.

Preferably, said semi-rigid plastic member is made from PVC.

Preferably, the exterior surface of said bottom wall is fitted with traction members.

Preferably, said traction members are comprised of rigid PVC.

Preferably, said traction members are spikes.

Preferably, said first entry point is adapted to fit hoses having larger diameters than said second entry point.

### BRIEF DESCRIPTION OF THE DRAWINGS

A preferred embodiment of the invention will now be described, by way of example only, with reference to the accompanying drawings in which:

FIG. 1 is a side view of an inflatable jack in accordance with the present invention.

FIG. 2 is a cutaway side view of the inflatable jack shown in FIG. 1.

### BEST MODE OF CARRYING OUT INVENTION

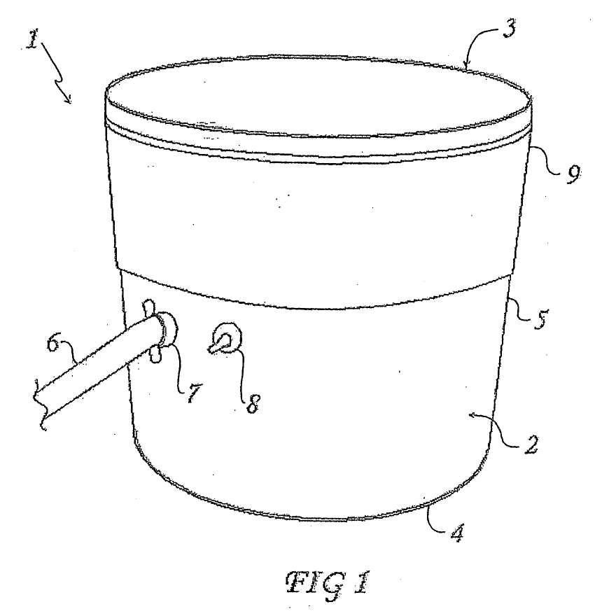

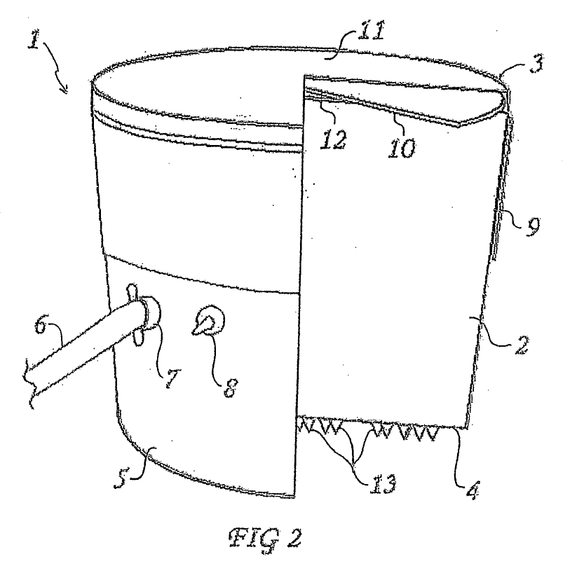

FIGS. 1 and 2 depict inflatable jack 1 in accordance with the present invention. Working chamber 2 is comprised of sealed flexible material having side wall 5, top wall 3 and bottom wall 4. In the figures, working chamber 2 is shown inflated. First and second entry points 7, 8 allow attaching a source of compressed air to inflate working chamber 2. First entry point 7 is adapted to fit one end of a hose 6 that is at its other end fitted over an exhaust pipe of a vehicle (not shown). Second entry point 8 is adapted to fit one end of a hose (not shown) that is at its other end fitted to an air compressor (not shown). The air compressor is a portable, electric compressor that plugs into the vehicle's electrical distribution system. Skirt 9 is disposed around the upper portion of side wall 5 to reinforce and protect working chamber 2 when inflated. Skirt 9 constricts outward extension of working chamber 2, thereby increasing the portion of hydraulic force acting in the upward direction.

FIG. 2 shows a cutaway of inflatable jack 1. The cutaway depicts traction spikes 13 disposed on the exterior surface of bottom wall 4. Fraction spikes 13 add stability to inflatable jack 1, which is important to the safety of the device. Traction spikes 13 are made from rigid PVC and particularly important when used on sand, mud, ice or snow. Top wall 3 of working chamber 2 is comprised of outer wall layer 11 and inner wall layer 12. Semi-rigid plastic member 10 is a PVC plate sandwiched between outer wall layer 11 and inner wall layer 12. Semi-rigid plastic member 10 protects working chamber 2 from being punctured by sharp edges on the undercarriage of the vehicle being lifted.

First and second entry points 7, 8 are sized to receive a plurality of hose diameters. First entry point 7 is sized for larger hoses, in the vicinity of an average vehicle exhaust pipe diameter. Second entry point 8 is sized to receive smaller hoses, as are common to small, portable air compressors. Either first or second entry point 7, 8 is used to inflate working chamber 2. Both entry points 7, 8 have non-return valves incorporated to prevent escape of compressed air whilst working chamber 2 is being inflated from the other entry point.

Inflatable jack 1 is particularly well suited to off-road, four-wheel drive vehicles. Well-equipped four-wheel drive vehicles commonly have a portable air compressor, which is then readily available for use with second entry point 8. First entry point 7 is intended to be a backup in the event that an air compressor is not available. Bottom wall 4 provides inflatable jack 1 with a larger distributed base than typical mechanical jacks, which are better suited to the stable surfaces provided by pavement. Traction spikes 13 further increase the stability provided by the large base of inflatable jack 1. Together these features greatly raise the prospects of being able to safely lift the vehicle in a variety of off-road environments.

In another not shown embodiment, traction spikes 13 may be replaced with ridges, formed in rings for example. Working chamber 2 may also have a safety valve to relieve pressure if working chamber 2 becomes over inflated.

The foregoing describes only a preferred embodiment of the present invention and modifications, obvious to those skilled in the art, can be made thereto without departing from the scope of the present invention.

The term “comprising” (and its grammatical variations) as used herein is used in the inclusive sense of “having” or “including” and not in the exclusive sense of “consisting only of”.

1. A inflatable jack for a vehicle, said inflatable jack comprising
a working chamber of sealed flexible material having a side wall, a top wall and a bottom wall, said top wall having an outer wall layer and an inner wall layer with a semi-rigid plastic member sandwiched there between,
first and second entry points for introducing compressed gas to inflate said working chamber,
said first entry point adapted to receive compressed gas via a hose from said vehicle's exhaust,
said second entry point adapted to receive compressed gas via a hose from an air compressor.

2. An inflatable jack for a vehicle as claimed in claim 1, wherein said air compressor is portable and powered from said vehicle's electrical distribution system.

3. An inflatable jack for a vehicle as claimed in claim 1, wherein a skirt is disposed around the upper portion of said side wall to reinforce said working chamber when inflated.

4. An inflatable jack for a vehicle as claimed in any one of claim 3, wherein said semi-rigid plastic member is made from PVC.

5. An inflatable jack for a vehicle as claimed in any one of claim 3, wherein the exterior surface of said bottom wall is fitted with traction members.

6. An inflatable jack for a vehicle as claimed in claim 5, wherein said traction members are comprised of rigid PVC.

7. An inflatable jack for a vehicle as claimed in claim 5, wherein said traction members are spikes.

8. An inflatable jack for a vehicle as claimed in any one of claim 3, wherein said first entry point is adapted to fit hoses having larger diameters than said second entry point.
